(19) United States
(12) Patent Application Publication
(10) Pub. No.: US 2006/0053453 A1
(43) Pub. Date: Mar. 9, 2006

(54) Wireless redistribution system for terrestrial digital television broadcasting and receiving system for terrestrial digital television broadcasting

(75) Inventors: Hideki Kasamatsu, Katano City (JP); Motoaki Asao, Higashiosaka City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 11/214,019

(22) Filed: Aug. 30, 2005

(30) Foreign Application Priority Data
Aug. 31, 2004 (JP) 2004-253460
Aug. 31, 2004 (JP) 2004-253462

(51) Int. Cl. H04N 7/18

(52) U.S. Cl. 725/81

(57) ABSTRACT

The present invention provides a wireless redistribution system for terrestrial digital TV broadcasting applied to a TV receiver capable of receiving signals of a VHF band in addition to signals of a UHF band as a frequency band of terrestrial digital TV broadcast signals. The system comprises: a transmitter, into which terrestrial digital TV broadcast signals received by an outdoor antenna are inputted, for converting the frequency of the inputted terrestrial digital TV broadcast signals to a frequency of an unused channel of the VHF band collectively, and then amplifying and transmitting them wirelessly; and a receiver for receiving and amplifying signals transmitted from the transmitter, and then supplying them to the TV receiver.

### BACKGROUND OF THE INVENTION

1. Field of the Invention

The present invention relates to a wireless redistribution system for terrestrial digital TV broadcasting and a receiving system for the terrestrial digital television broadcasting.

2. Description of the Related Art

In Japan, the terrestrial digital TV broadcasting started on Dec. 1, 2003 in three metropolitan areas of Kanto, Chukyo and Kinki. The terrestrial digital TV broadcasting adopts an OFDM (Orthogonal Frequency Division Multiplexing) system not being subject to multipath interference, enabling stable high quality reception with little double-reflection of images (ghost defect) which have been caused in the analog TV broadcasting or the like. The terrestrial digital TV broadcasting is performed on the UHF band (470 to 770 MHz).

As modes of receiving the terrestrial digital TV broadcasting with a terrestrial digital TV receiver, generally, there are following types.

(1) Terrestrial digital TV broadcast signals are received by an outdoor antenna. The terrestrial digital TV broadcast signals received by the outdoor antenna are distributed to each room with antenna cables, and guided to a TV terminal provided on a wall of each room. To the TV terminal provided on a wall of each room, an antenna terminal of a terrestrial digital TV receiver is connected via an antenna cable.

In such a reception mode, an antenna terminal of a terrestrial digital TV receiver must be connected to a TV terminal provided on a wall via an antenna cable. This deteriorates the outer appearance and also causes a problem of the wiring being troublesome. Further, layouts of the TV receiver are limited; therefore, the degree of freedom in arrangement positions of the TV receiver is impaired.

(2) An UHF antenna (e.g., UDMF62: manufactured by Nippon Antenna) is provided at an edge of the eaves or veranda without providing an antenna on the rooftop (on the roof), and an antenna cable is drawn into a room therefrom so as to connect directly to an antenna terminal of a terrestrial digital TV receiver.

Even in such a reception mode, an antenna cable must be drawn into a room so as to be connected to a terrestrial digital TV receiver. This also deteriorates the outer appearance and causes a problem of the wiring being troublesome. Further, layouts of the TV receiver are limited; therefore, the degree of freedom in arrangement positions of the TV receiver is impaired.

(3) The terrestrial digital TV broadcast signals are received by an indoor antenna connected to a terrestrial digital TV receiver.

In such a reception mode, limitation in the layouts of the TV receiver caused by wiring of an antenna cable is solved. However, there is a problem that a radio wave shield loss in the room is caused. Particularly, in the UHF band used for terrestrial digital TV broadcast signals, attenuation loss when passing through a building is large comparing with the VHF band used in the terrestrial analog TV broadcasting; therefore, there is a problem that arrangement positions of a TV receiver are limited from the viewpoint of the receiving sensitivity.

Thus, there has been developed an indoor redistribution system in which terrestrial digital TV broadcast signals inputted into a room are amplified by a wireless transmitter, and are retransmitted to a TV receiver wirelessly (see JP-A 2004-128719 and JP-A 2004-128720). In this indoor retransmission system, terrestrial digital TV broadcast signals of the UHF band, inputted into a room, are amplified directly and retransmitted, without being frequency-converted.

In the frequency of the UHF band, a transmission output level of a wireless transmitter is limited to a very low level as described later. This causes a problem that only a short range transmission is possible.

Further, when both of the direct broadcast radio wave transmitted from a broadcasting station and the retransmitted radio wave transmitted from a wireless transmitter are received and inputted in an indoor reception antenna, signals of the same frequency channel are inputted in a TV receiver. Thereby, there may be a case where interference disturbance of the same channel is caused and reception becomes impossible.

In order to prevent such a case, antennas or circuits must be added with devises for preventing deterioration caused by the same channel disturbance of terrestrial digital TV broadcast signals.

### SUMMARY OF THE INVENTION

An object of the present invention is to provide a wireless redistribution system for terrestrial digital TV broadcasting in which interference disturbance of the same channel of terrestrial digital TV broadcast signals can be prevented by performing frequency conversion on a transmitter side, and frequency conversion is not required on a receiver side.

Another object of the present invention is to provide a receiving system for terrestrial digital TV broadcasting, capable of reproducing TV broadcast signals of higher receiving quality out of TV broadcast signals supplied by a wireless redistribution system for wirelessly retransmitting terrestrial digital TV broadcast signals received by an outdoor antenna to a TV receiver and TV broadcast signals supplied by a direct receiving system for directly inputting terrestrial digital TV broadcast signals into a TV receiver via an indoor antenna.

According to a first aspect of the present invention, a wireless redistribution system for terrestrial digital TV broadcasting is applied to a TV receiver capable of receiving signals of a VHF band in addition to signals of a UHF band as a frequency band of terrestrial digital TV broadcast signals. The wireless redistribution system comprises: a transmitter, into which terrestrial digital TV broadcast signals received by an outdoor antenna are inputted, for converting a frequency of the inputted terrestrial digital TV broadcast signals to a frequency of an unused channel of the VHF band collectively, and then amplifying and transmitting them wirelessly; and a receiver for receiving and amplifying signals transmitted from the transmitter, and then supplying them to the TV receiver.

An example of the transmitter includes a transmitter which converts the frequency of the inputted terrestrial digital TV broadcast signals to a frequency of an unused channel of the VHF band within a range between 260 MHz and 470 MHz collectively, and then amplifies and transmits them wirelessly.

According to a second aspect of the present invention, a wireless redistribution system for terrestrial digital TV broadcasting is applied to a TV receiver capable of receiving TV broadcast signals of a VHF band in addition to TV broadcast signals of a UHF band as a frequency band of terrestrial digital TV broadcast signals. The wireless redistribution system comprises: a transmitter into which terrestrial digital TV broadcast signals or terrestrial digital TV broadcast signals having been frequency-converted to the VHF band are inputted, in which when inputted TV broadcast signals are terrestrial digital TV broadcast signals of the UHF band, the transmitter converts the frequency of the inputted TV broadcast signals to a frequency of an unused channel of the VHF band collectively and then amplifies and transmits them wirelessly, and when the inputted TV broadcast signals are terrestrial digital TV broadcast signals having been frequency-converted to the VHF band, the transmitter amplifies the inputted TV broadcast signals straightly and transmits them wirelessly; and a receiver for receiving and amplifying signals transmitted from the transmitter, and then supplying them to the TV receiver.

An example of the transmitter includes a transmitter which includes: first means for extracting TV broadcast signals of the VHF band from the inputted TV broadcast signals, and based on a signal level of the TV broadcast signals of the VHF band extracted, determining whether the inputted TV broadcast signals are the terrestrial digital TV broadcast signals of the UHF band or the terrestrial digital TV broadcast signals having been frequency-converted to the VHF band; second means for converting the frequency of the inputted TV broadcast signals to a frequency of an unused channel of the VHF band collectively and then amplifying and transmitting them wirelessly, when the inputted TV broadcast signals are determined as the terrestrial digital TV broadcast signals of the UHF band; and third means for amplifying and wirelessly transmitting the inputted TV broadcast signals straightly, when the inputted TV broadcast signals are determined as the terrestrial digital TV broadcast signals having been frequency-converted to the VHF band.

An example of the second means includes means for converting the frequency of the inputted TV broadcast signals to a frequency of an unused channel of the VHF band within a range between 260 MHz and 470 MHz collectively, and then amplifying and transmitting them wirelessly.

According to the present invention, a receiving system for terrestrial digital TV broadcasting comprises: a wireless redistribution system for wirelessly retransmitting terrestrial digital TV broadcast signals received by an outdoor antenna to a TV receiver; and a direct receiving system for inputting terrestrial digital TV broadcast signals to the TV receiver directly via an indoor antenna. Herein, the TV receiver includes: selection means for selecting TV broadcast signals of higher receiving quality out of the TV broadcast signals supplied by the wireless redistribution system and the TV broadcast signals supplied by the direct receiving system; and reproduction means for reproducing the TV broadcast signals selected by the selection means.

An example of the selection means includes means for comparing a received signal level of the TV broadcast signals supplied by the wireless redistribution system with a received signal level of the TV broadcast signals supplied by the direct receiving system to thereby select TV broadcast signals of higher receiving quality.

Another example of the selection means includes means for comparing a received signal error rate of the TV broadcast signals supplied by the wireless redistribution system with a received signal error rate of the TV broadcast signals supplied by the direct receiving system to thereby select TV broadcast signals of higher receiving quality.

An example of the wireless redistribution system includes a wireless redistribution system which comprises: a transmitter for converting a frequency of the terrestrial digital TV broadcast signals received by the outdoor antenna to a frequency of an unused channel of the VHF band, and then amplifying and transmitting them wirelessly; and a receiver for receiving and amplifying signals transmitted from the transmitter and then supplying them to the TV receiver.

An example of the transmitter includes a transmitter which converts a frequency of the terrestrial digital TV broadcast signals received by the outdoor antenna to a frequency of an unused channel of the VHF band within a range between 260 MHz and 470 MHz collectively, and then amplifies and transmits them wirelessly.

### BRIEF DESCRIPTION OF THE DRAWINGS

FIG. 1 is a graph showing the electric field intensity (allowance) with respect to frequency bands defined in the weak radio wave standard;

FIG. 2 is a schematic diagram showing the overview of a wireless redistribution system for terrestrial digital TV broadcasting;

FIG. 3 is a block diagram showing the configuration of a transmitter of FIG. 2;

FIG. 4 is a schematic diagram for illustrating frequency conversion by the frequency conversion unit of FIG. 3;

FIG. 5 is a block diagram showing the configuration of a receiver;

FIG. 6 is a block diagram showing another example of a transmitter;

FIG. 7 is a schematic diagram showing the overview of a wireless redistribution system for terrestrial digital TV broadcasting;

FIG. 8 is a block diagram showing the configuration of a transmitter of FIG. 7;

FIG. 9 is a schematic diagram for illustrating frequency conversion by the frequency conversion unit;

FIG. 10 is a block diagram showing the configurations of a receiver and a TV receiver;

FIG. 11 is a block diagram showing a first modification of the TV receiver;

FIG. 12 is a block diagram showing a second modification of the TV receiver; and

FIG. 13 is a block diagram showing a third modification of the TV receiver.

### DETAILED DESCRIPTION OF PREFERRED EMBODIMENTS

A. Description of First Embodiment

1. Description of Terrestrial Digital Broadcasting TV Receiver to which this Invention is Applied

Table 1 shows each reception channel and center frequency of the terrestrial digital TV broadcasting in Japan.

TABLE 1

| Reception channel | Center frequency |
|---|---|
| UHF13 | 473 + 1/7 MHz |
| UHF14 | 479 + 1/7 MHz |
| UHF15 | 485 + 1/7 MHz |
| . | . |
| . | . |
| . | . |
| UHF61 | 761 + 1/7 MHz |
| UHF62 | 767 + 1/7 MHz |

The reception channels of the terrestrial digital TV broadcasting are UHF13ch to UHF62ch. The center frequencies are 473+1/7 MHz for 13ch, 479+1/7 MHz for 14ch, and 767+1/7 MHz for 62ch.

The frequency band to which the terrestrial digital TV broadcasting is introduced is a range between UHF13ch and UHF62ch; therefore, it is required to receive the frequency as a receiving frequency range of a terrestrial digital broadcasting TV receiver.

Currently, the broadcasting has been started from December, 2003 in three metropolitan areas (Kanto wide area, Chukyo wide area, Kinki wide area). The broadcasting in the Kinki area, for example, is performed as shown in Table 2.

TABLE 2

| Reception | | |
|---|---|---|
| channel | Center frequency | Broadcasting station |
| UHF13 | 473 + 1/7 MHz | NHK Education |
| UHF14 | 479 + 1/7 MHz | Yomiuri TV |
| UHF15 | 485 + 1/7 MHz | Asahi Broadcasting |
| UHF16 | 491 + 1/7 MHz | Mainichi Broadcasting |
| UHF17 | 497 + 1/7 MHz | Kansai TV |
| UHF18 | 503 + 1/7 MHz | TV Osaka |
| UHF24 | 539 + 1/7 MHz | NHK General |

On the other hand, as for the reception mode of the current terrestrial analog TV broadcasting, community reception accounts for almost half of all households, if community viewing in multiple dwelling houses is included. In the transmission band in the community viewing facilities, most are not wide-banded up to the UHF band, and the UHF TV broadcasting is transmitted by being down-converted to unused channels (channels unused in the area) of low frequency such as VHF_Low/High (VHF low/high band), VHF_MID (VHF mid band) and VHF_SHB (VHF super high band), or the like.

Therefore, community reception is anticipated even for stationary-type TV receivers for the terrestrial digital TV broadcasting, in particular. Therefore, ARIB standard ARIB STD-B21 defines that the range of reception channels of a terrestrial digital broadcasting receiver desirably supports VHF_Low/High band (VHF1ch to VHF12ch), VHF_MID band (C13ch to C22ch) and VHF_SHB band (C23ch to C63ch), in addition to the UHF band.

Accordingly, it is considered that a stationary-type TV receiver for the terrestrial digital TV broadcasting is designed so as to be able to receive the VHF_Low/High band (VHF1ch to VHF12ch), the VHF_MID band (C13ch to C22ch) and the VHF_SHB band (C23ch to C63ch), in addition to the UHF band.

Table 3 shows each reception channel and the center frequency in the VHF_Low/High band (VHF1ch to VHF12ch).

TABLE 3

| Reception channel | Center frequency |
|---|---|
| VHF1ch | 93 + 1/7 MHz |
| VHF2ch | 99 + 1/7 MHz |
| VHF3ch | 105 + 1/7 MHz |
| VHF4ch | 173 + 1/7 MHz |
| VHF5ch | 179 + 1/7 MHz |
| VHF6ch | 185 + 1/7 MHz |
| VHF7ch | 191 + 1/7 MHz |
| VHF8ch | 195 + 1/7 MHz |
| VHF9ch | 201 + 1/7 MHz |
| VHF10ch | 207 + 1/7 MHz |
| VHF11ch | 213 + 1/7 MHz |
| VHF12ch | 219 + 1/7 MHz |

Table 4 shows each reception channel and the center frequency in the VHF_MID band (C13ch to C22ch).

TABLE 4

| Reception channel | Center frequency |
|---|---|
| C13ch | 111 + 1/7 MHz |
| C14ch | 117 + 1/7 MHz |
| C15ch | 123 + 1/7 MHz |
| C16ch | 129 + 1/7 MHz |
| C17ch | 135 + 1/7 MHz |
| C18ch | 141 + 1/7 MHz |
| C19ch | 147 + 1/7 MHz |
| C20ch | 153 + 1/7 MHz |
| C21ch | 159 + 1/7 MHz |
| C22ch | 165 + 1/7 MHz |

Table 5 shows each reception channel and the center frequency in the VHF_SHB band (C23ch to C63ch).

TABLE 5

| Reception channel | Center frequency |
|---|---|
| C23ch | 225 + 1/7 MHz |
| C24ch | 231 + 1/7 MHz |
| C25ch | 237 + 1/7 MHz |
| . | . |
| . | . |
| . | . |
| C63ch | 465 + 1/7 MHz |

The present invention is also subject to be applied to a TV receiver for the terrestrial digital TV broadcasting capable of receiving (selectively viewing) the VHF_Low/High band (VHF1ch to VHF12ch), the VHF_MID band (C13ch to C22ch) and the VHF_SHB band (C23ch to C63ch), in addition to the original UHF band 13ch to 62ch (470 MHz to 770 MHz).

2. Description of Weak Radio Wave Standard

Description will be given for the Japanese standard of weak radio wave. The weak radio wave standard is defined by an ordinance of the Ministry of Internal Affairs and Communications, as wireless equipment emitting significantly weak radio waves, which is defined by the electric field intensity at a point of 3 meters away.

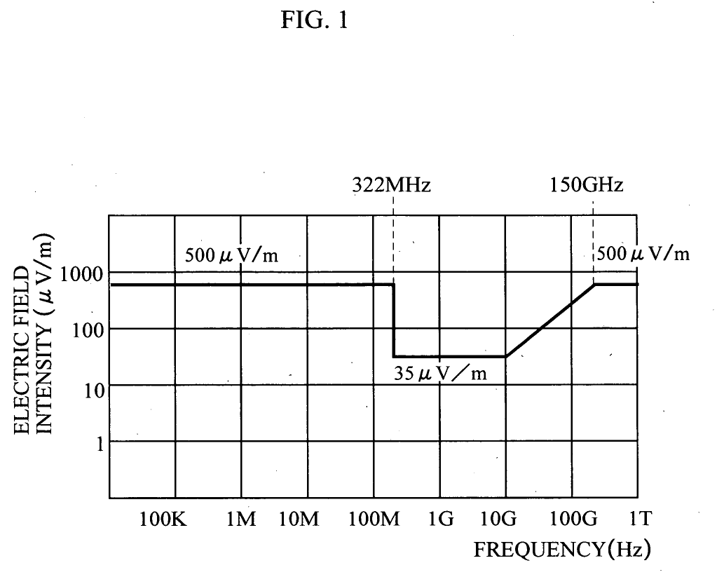

FIG. 1 and Table 6 show the electric field intensity with respect to the frequency bands defined in the weak radio wave standard (allowance).

TABLE 6

| | Electric field intensity |
|---|---|
| Frequency band | at point of 3 m away |
| Less than 322 MHz | 500 μV/m |
| 322 MHz to 10 GHz | 35 μV/m |
| 10 GHz to 150 GHz | 3.5 fμV/m in a range not exceeding |
| | 500 μV/m |
| | (f: frequency shown by GHz) |
| More than 150 GHz | 500 μV/m |

As shown in Table 6, as for the frequency band which is less than 322 MHz or more than 150 GHz, the allowance is limited to 500 μV/m. Further, as for the frequency band in a range between 322 MHz and 10 GHz, the allowance is limited to 35 μV/m, considering the interference prevention with respect to field moving works, UHF, TV broadcasting, fixed works and space works (earth station). Further, as for frequency band in a range between 10 GHz and 150 GHz, the allowance is limited to 3.5 fμV/m (f: used frequency band (GHz)) considering the system noise temperature, receiving band width and the like.

A wireless system under the wireless standard of weak radio wave has no restriction in frequency, modulating system and communication system if it satisfies the electric field intensity shown in Table 6. Therefore, a relatively free system design is possible.

3. Description of Wireless Redistribution System for Terrestrial Digital TV Broadcasting

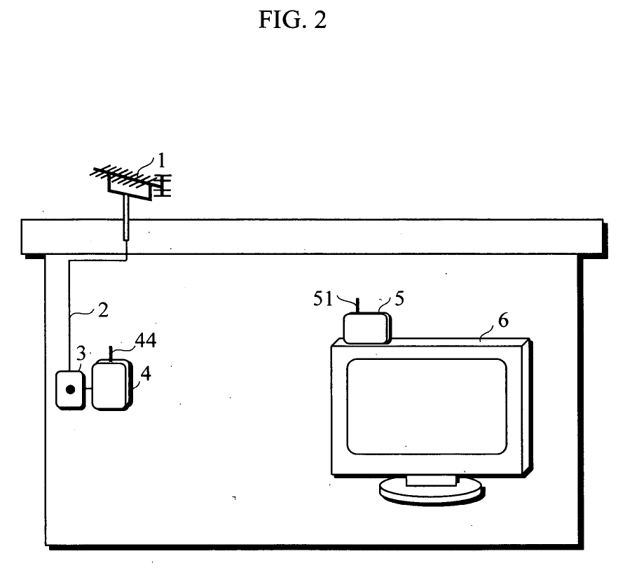

FIG. 2 shows the overview of a wireless redistribution system for terrestrial digital TV broadcasting.

Terrestrial digital TV broadcast signals are received by an outdoor antenna 1 provided on the rooftop. The terrestrial digital TV broadcast signals received by the outdoor antenna 1 are guided to a TV terminal 3 provided on a wall of a room by an antenna cable 2.

To the TV terminal 3, a transmitter 4 for redistribution is connected. The transmitter 4 frequency-converts all broadcast reception channels (reception channels of the terrestrial digital TV broadcasting) collectively such that the terrestrial digital TV broadcast signals obtained from the TV terminal 3 are multiplexed with an unused channel of the VHF band (in this example, VHF_SHB band) less than 322 MHz where restriction in the weak radio wave standard is lenient, and then wirelessly retransmits them from a transmission antenna 44 with a weak radio wave not more than the allowance (500 μV/m) of the weak radio wave standard.

To a TV receiver 6 for terrestrial wave digital TV broadcasting, a receiver 5 for redistribution is connected. The TV receiver 6 for the terrestrial digital TV broadcasting has a TV tuner (terrestrial digital broadcasting TV tuner supporting VHF reception) capable of receiving (capable of selecting and viewing a channel) VHF_Low/High band (VHF1ch to VHF12ch), VHF_MID band (C13ch to C22ch) and VHF_SHB band (C23ch to C63ch), in addition to the original UHF band 13ch to 62ch (470 MHz to 770 MHz).

The receiver 5 receives the redistributed signals transmitted from the transmitter 4 through a reception antenna 51, amplifies the received signals to a predetermined level receivable by the TV tuner inside the TV receiver 6, and then transmits them to the TV receiver 6.

In the TV receiver 6, a channel (unused channel) of the VHF_SHB is selected, whereby the terrestrial digital TV broadcasting is broadcasted.

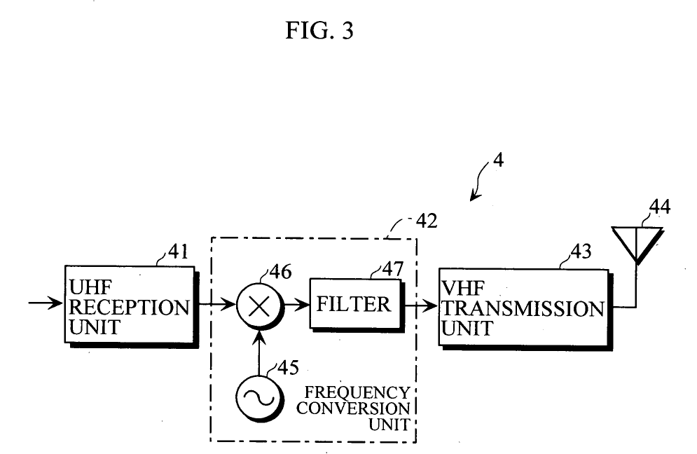

FIG. 3 shows the configuration of the transmitter 4.

The transmitter 4 includes a UHF reception unit 41, a frequency conversion unit 42, a VHF transmission unit 43 and the transmission antenna 44.

Terrestrial digital TV broadcast signals received by the outdoor antenna 1 are amplified by the UHF reception unit 41, and then transmitted to the frequency conversion unit 42. In the frequency conversion unit 42, all terrestrial digital TV broadcast signals received (received signals) and local signals outputted from an oscillation unit 45 oscillating with a fixed frequency are mixed by a mixer 46. From the mixer 46, added signals and subtracted signals of the respective received signals and the local signals are outputted. For example, assuming that the frequency of the received signals is fa and the frequency of the local signals is fb, added signals that the frequency thereof is fa+fb and subtracted signals that the frequency thereof is fa−fb are outputted from the mixer 46. The outputs of the mixer 46 are transmitted to a filter 47, and only the subtracted signals are extracted.

The frequency fb of the local signals is set such that the frequency (fa−fb) of the subtracted signals outputted from the mixer 46 becomes a frequency of an unused channel of the VHF band (in this example, VHF_SHB band) less than 322 MHz where restriction in the weak radio wave standard is lenient. In the Kinki wide area in which channels through which the terrestrial digital TV broadcasting is performed and the center frequencies are shown in Table 2, the frequency fb of the local signals are set to 224 MHz, for example. In the case where the frequency fb of the local signals is set in this way, the VHF transmission channels after frequency conversion, center frequencies, broadcasting stations, and corresponding UHF channels are as shown in Table 7.

TABLE 7

| Transmission | | Broadcasting | Corresponding |
|---|---|---|---|
| channel | Center frequency | station | UHF channel |
| VHF_SHB C27 | 249 + 1/7 MHz | NHK Education | UHF13 |
| VHF_SHB C28 | 255 + 1/7 MHz | Yomiuri TV | UHF14 |
| VHF_SHB C29 | 261 + 1/7 MHz | Asahi | UHF15 |
| | | Broadcasting | |
| VHF_SHB C30 | 267 + 1/7 MHz | Mainichi | UHF16 |
| | | Broadcasting | |
| VHF_SHB C31 | 273 + 1/7 MHz | Kansai TV | UHF17 |
| VHF_SHB C32 | 279 + 1/7 MHz | TV Osaka | UHF18 |
| VHF_SHB C38 | 315 + 1/7 MHz | NHK General | UHF24 |

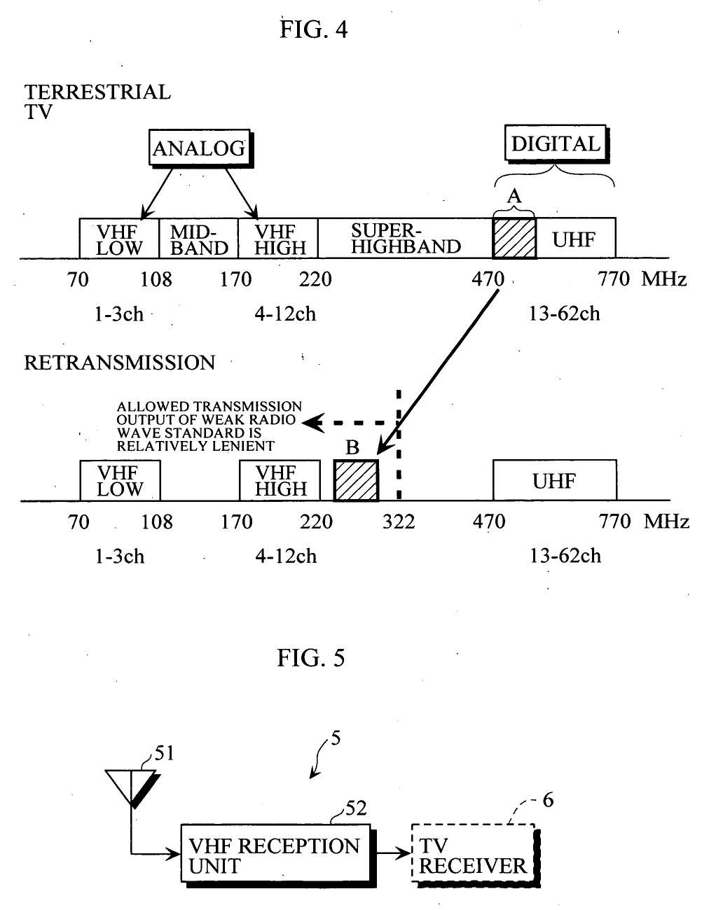

That is, as shown in FIG. 4, assuming that all channels of the terrestrial digital TV broadcast signals received by the outdoor antenna 1 is A, all channels A of the terrestrial digital TV broadcast signals is frequency-converted by the frequency conversion unit 42 to an unused channel B of the VHF_SHB band less than 322 MHz.

The terrestrial digital TV broadcast signals frequency-converted to the VHF_SHB band by the frequency conversion unit 42 are amplified by the VHF transmission unit 43, and transmitted wirelessly from the transmission antenna 44. In the VHF transmission unit 43, AGC is performed in such a manner that the signal level, transmitted wirelessly, does not exceed the allowance defined by the weak radio wave standard.

FIG. 5 shows the configuration of the receiver 5.

The receiver 5 includes a reception antenna 51 and a VHF reception unit 52.

Terrestrial digital TV broadcast signals transmitted wirelessly from the transmitter 4 are received by the reception antenna 51. The terrestrial digital TV broadcast signals having been frequency-converted, received by the reception antenna 51, are amplified by the VHF reception unit 52, and then transmitted to a terrestrial digital broadcasting TV tuner supporting VHF reception inside the TV receiver 6 for the terrestrial digital TV broadcasting.

A user designates a specific channel of the VHF_SHB in the TV receiver 6, whereby the user can view the terrestrial digital broadcasting. In the example shown in Table 7, when a channel “C27” is designated, selecting operation for selecting the channel “C27” is performed in the TV receiver 6, whereby the terrestrial digital broadcasting of the UHF13 channel is broadcasted.

In the above embodiment, the frequency conversion unit 42 converts the frequency of the terrestrial digital TV broadcast signals to a frequency of an unused channel of the VHF_SHB band less than 322 MHz. However, the frequency of the terrestrial digital TV broadcast signals may be converted to a frequency of an unused channel of the VHF_Low/High band or the VHF_MID band which is less than 322 MHz.

In the above embodiment, frequency conversion is performed by the transmitter 4; therefore, it is possible to prevent occurrence of same channel interference of terrestrial digital TV broadcast signals. Further, since the transmitter 4 converts the frequency of terrestrial digital TV broadcast signals to a frequency of the VHF band selectable and operable by the TV receiver 6, the receiver 5 is not required to invert the frequency of the received signals to the original frequency. This provides an advantage that the circuit configuration of the receiver is simple and inexpensive.

4. Description of Modification of Transmitter

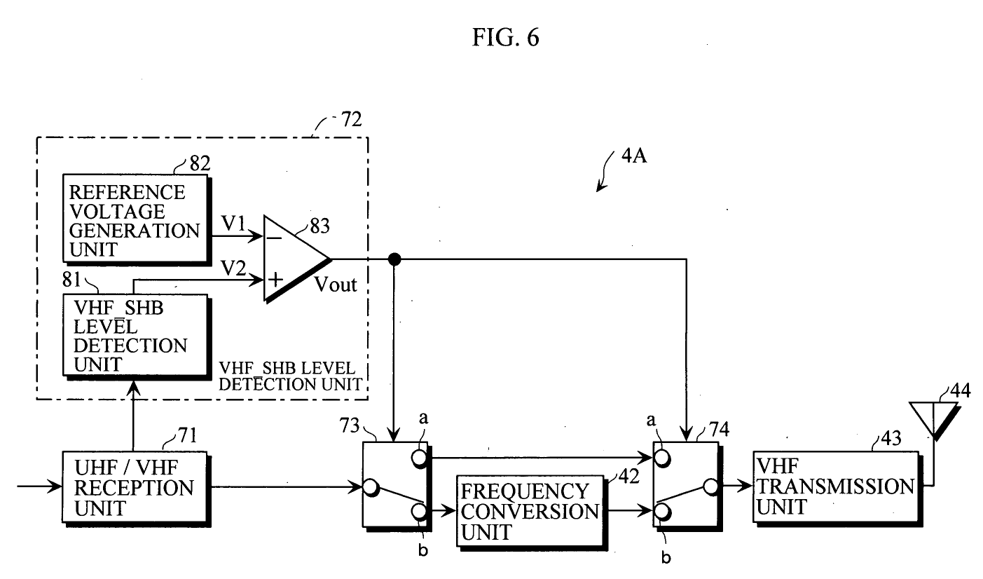

FIG. 6 shows a modification of a transmitter.

The transmitter 4A is connected to a TV terminal (not shown) provided on a wall. The TV terminal provided on a wall may be connected to the outdoor antenna as shown in FIG. 2. However, in a community viewing TV receiving system such as in multiple dwelling houses, terrestrial digital TV broadcast signals which have been down-converted to the VHF_SHB band may be supplied to the TV terminal.

Accordingly, in the transmitter 4A, if inputted signals are terrestrial digital TV broadcast signals from the outdoor antenna, the signals are frequency-converted and then transmitted wirelessly similar to the case of the transmitter 4 in FIG. 3. If inputted signals are those already down-converted, the signals are transmitted without being frequency-converted.

The transmitter 4A includes a UHF/VHF reception unit 71, a VHF_SHB level detection unit 72, a first selection switch 73, a frequency conversion unit 42, a second selection switch 74, a VHF transmission unit 43 and a transmission antenna 44. The frequency conversion unit 42; the VHF transmission unit 43 and the transmission antenna 44 are same as the frequency conversion unit 42, the VHF transmission unit 43 and the transmission antenna 44 of the transmitter 4 shown in FIG. 3.

Terrestrial digital TV broadcast signals of the UHF band or terrestrial digital TV broadcast signals of the VHF_SHB band which have been down-converted, inputted from the TV terminal not shown, are amplified by the UHF/VHF reception unit 71, and then transmitted to the VHF_SHB level detection unit 72 and to the first selection switch 73.

The VHF_SHB level detection unit 72 includes a VHF_SHB level detection unit 81, a reference voltage generation unit 82 and a comparator 83. The VHF_SHB level detection unit 81 extracts signals of the VHF SHB band from the signals transmitted from the UHF/VHF reception unit 71 by a BPF (bandpass filter) or the like, and converts the extracted signals to be in a direct current (DC) signal level by a level detection circuit. As an LSI realizing such a circuit, LT5534 manufactured of Linear Technology Corporation is used, for example.

A reference voltage V1 outputted from the reference voltage generation unit 82 is inputted to the negative input terminal of the comparator 83, and a voltage V2 outputted from the VHF_SHB level detection unit 81 is inputted to the positive input terminal of the comparator 83. The comparator 83 sets an output signal Vout as an H level when V2>V1, and sets an output signal Vout as an L level when V2<V1.

An output signal Vout of the comparator 83 is transmitted to the first selection switch 73 and the second selection switch 74, as a control signal. When a Vout is in the H level (V2>V1), the respective switches 73 and 74 switch the section to “a” side. When a Vout is in the L level (V2<V1), the respective switches 73 and 74 switch the section to “b” side.

Therefore, when a Vout is in the H level, that is, when the signal level of the VHF_SHB band is larger, it is determined that terrestrial digital TV broadcast signals of the VHF_SHB band down-converted are inputted in the UHF/VHF reception unit 71, and signals outputted from the UHF/VHF reception unit 71 are transmitted to the VHF transmission unit 43 via the respective switches 73 and 74, and then transmitted wirelessly from the transmission antenna 44.

In contrast, when a Vout is in the L level, that is, when the signal level of the VHF_SHB band is smaller, it is determined that terrestrial digital TV broadcast signals of the UHF band are inputted in the UHF/VHF reception unit 71. Signals outputted from the UHF/VHF reception unit 71 are transmitted to the frequency conversion unit 42 via the first switch 73, and are frequency-converted so as to be a frequency of an unused channel of the VHF_SHB band less than 322 MHz. The terrestrial digital T broadcast signals after frequency conversion are transmitted to the VHF transmission unit 43 via the second switch 74, and then transmitted wirelessly from the transmission antenna 44.

B. Description of Second Embodiment

1. Description of Receiving System for Terrestrial Digital TV Broadcasting

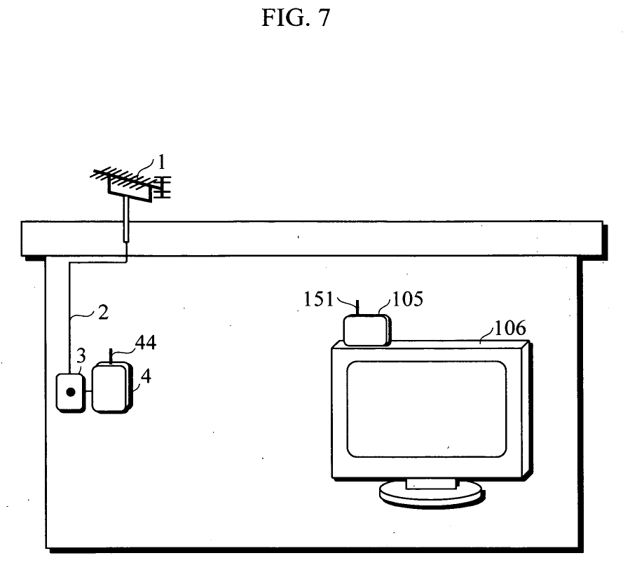

FIG. 7 shows the overview of a receiving system for terrestrial digital TV broadcasting.

Terrestrial digital TV broadcast signals are received by the outdoor antenna 1 provided on the rooftop. The terrestrial digital TV broadcast signals received by the outdoor antenna 1 are guided to the TV terminal 3 provided on a wall of a room by an antenna cable 2.

To the TV terminal 3, the transmitter 4 for redistribution is connected. The transmitter 4 collectively frequency-converts all broadcast reception channels (reception channels of the terrestrial digital TV broadcasting) such that the terrestrial digital TV broadcast signals obtained from the TV terminal 3 are multiplexed with an unused channel of the VHF band (in this example, VHF_SHB band) less than 322 MHz where restriction in the weak radio wave standard is lenient. Then, the transmitter 4 retransmits them wirelessly from the transmission antenna 44 with weak radio wave less than the allowance (500 μV/m) of the weak radio wave standard.

To the TV receiver 106 for the terrestrial digital TV broadcasting, a receiver 105 for redistribution is connected. The TV receiver 106 for the terrestrial digital TV broadcasting has a TV tuner (terrestrial digital broadcasting TV tuner supporting VHF reception) capable of receiving (selectively viewing) the VHF_Low/High band (VHF1ch to VHF12ch), the VHF_MID band (C13ch to C22ch) and VHF_SHB band (C23ch to C63ch), in addition to the original UHF band 13ch to 62ch (470 MHz to 770 MHz).

The receiver 105 includes a reception antenna 151 for receiving retransmitted wave (retransmitted wave of VHF band) from the transmitter 4 and direct wave (direct wave of UHF band) of the terrestrial digital TV broadcasting. The receiver 105 transmits the retransmitted wave and the direct wave of the terrestrial digital TV broadcasting received by the reception antenna 151 to the TV receiver 106.

The TV receiver 106 selects and reproduces wave of higher receiving quality out of the retransmitted wave of the VHF band and the direct wave of the UHF band.

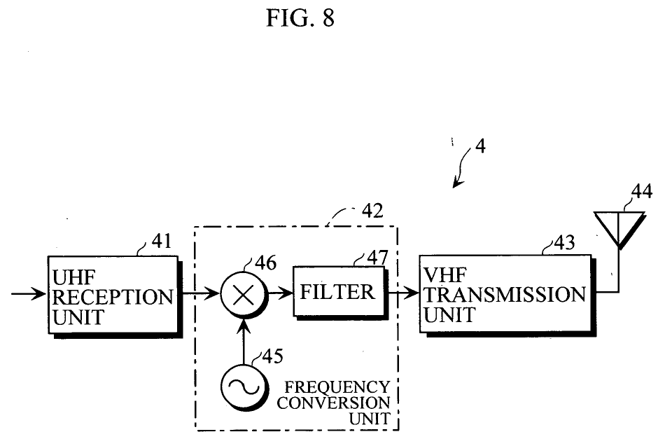

FIG. 8 shows the configuration of the transmitter 4.

The transmitter 4 includes a UHF reception unit 41, a frequency conversion unit 42, a VHF transmission unit 43, and a transmission antenna 44.

Terrestrial digital TV broadcast signals received by the outdoor antenna 1 are amplified by the UHF reception unit 41, and then transmitted to the frequency conversion unit 42. In the frequency conversion unit 42, all terrestrial digital TV broadcast signals received (received signals) and local signals from the oscillation unit 45 oscillating with a fixed frequency are mixed by the mixer 46. From the mixer 46, added signals and subtracted signals of the respective received signals and local signals are outputted. For example, assuming that the frequency of the received signals is fa and the frequency of the local signals is fb, the added signals that the frequency thereof is fa+fb and the subtracted signals that the frequency thereof is fa−fb are outputted from the mixer 46. The outputs of the mixer 46 are transmitted to a filter 47, and only subtracted signals are extracted.

The frequency fb of the local signals is set such that the frequency of the subtracted signals (fa−fb) outputted from the mixer 46 becomes a frequency of an unused channel of the VHF band (in this example, VHF_SHB band) less than 322 MHz where restriction in the weak radio wave standard is lenient.

In the Kinki wide area in which channels through which the terrestrial digital TV broadcasting is performed and the center frequencies are shown in Table 2, the frequency fb of the local signals are set to 224 MHz, for example. When the frequency fb of the local signals is set in this way, VHF transmission channels after frequency conversion, center frequencies, broadcasting stations and corresponding channels are as shown in Table 8.

TABLE 8

| Transmission | | Broadcasting | Corresponding |
|---|---|---|---|
| channel | Center frequency | station | UHF channel |
| VHF_SHB C27 | 249 + 1/7 MHz | NHK Education | UHF13 |
| VHF_SHB C28 | 255 + 1/7 MHz | Yomiuri TV | UHF14 |
| VHF_SHB C29 | 261 + 1/7 MHz | Asahi | UHF15 |
| | | Broadcasting | |
| VHF_SHB C30 | 267 + 1/7 MHz | Mainichi | UHF16 |
| | | Broadcasting | |
| VHF_SHB C31 | 273 + 1/7 MHz | Kansai TV | UHF17 |
| VHF_SHB C32 | 279 + 1/7 MHz | TV Osaka | UHF18 |
| VHF_SHB C38 | 315 + 1/7 MHz | NHK General | UHF24 |

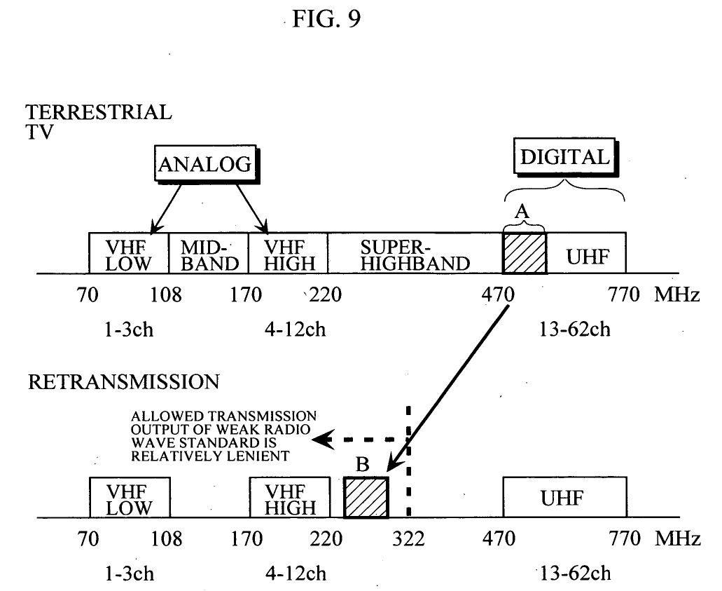

That is, as shown in FIG. 9, assuming that all channels of the terrestrial digital TV broadcast signals received by the outdoor antenna 1 is A, all channels A of the terrestrial digital TV broadcast signals is frequency-converted by the frequency conversion unit 42 to an unused channel B of the VHF_SHB band less than 322 MHz. Therefore, in the TV receiver 106, the terrestrial digital TV broadcasting can be viewed by selecting any channel of the unused channels B of the VHF_SHB band.

The terrestrial digital TV broadcast signals frequency-converted to the VHF_SHB band by the frequency conversion unit 42 are amplified by the VHF transmission unit 43, and transmitted wirelessly from the transmission antenna 44. In the VHF transmission unit 43, AGC is performed in such a manner that the signal level, transmitted wirelessly, does not exceed the allowance defined by the weak radio wave standard.

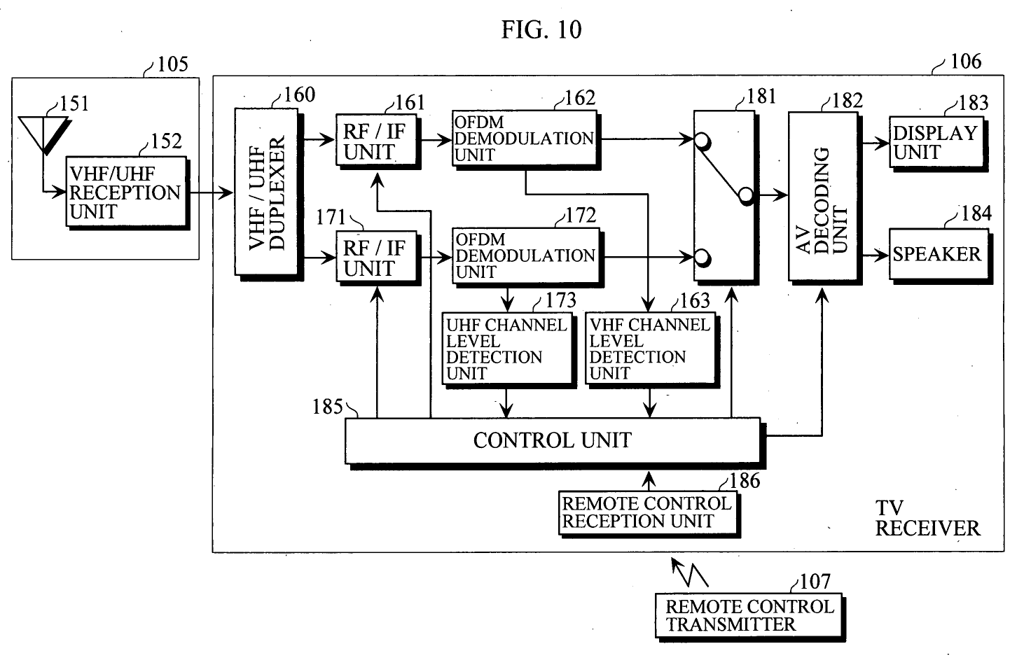

FIG. 10 shows the configurations of a receiver 105 and a TV receiver 106.

The receiver 105 includes a reception antenna 151 and a VHF/UHF reception unit 152.

The reception antenna 151 receives retransmitted wave from the transmitter 4 (retransmitted wave of the VHF band) and direct wave of the terrestrial digital TV broadcasting (direct wave of the UHF band). The retransmitted wave of the VHF band and the direct wave of the UHF band received by the reception antenna 151 are amplified by the VHF/UHF reception unit 152, and then transmitted to the TV receiver 106.

The TV receiver 106 includes a VHF/UHF duplexer 160 and two receiving systems. Each receiving system includes an RF/IF unit 161 or 171 and an OFDM demodulation unit 162 or 172.

On the TV receiver 106 side, a user designates a desired channel (UHF channel) of the terrestrial digital TV broadcasting by the remote control transmitter 107. The UHF channel designated by the remote control transmitter 107 is inputted in a control unit 185 via the remote control reception unit 186. The control unit 185 obtains a VHF channels corresponding to the inputted UHF channel, based on a table, as shown in Table 8 above, indicating the relationship between UHF channels and VHF channels (unused channel of VHF_SHB) corresponding thereto.

The control unit 185 controls the first RF/IF unit 161 such that a VHF channel corresponding to the designated UHF channel is selected, and controls the second RF/IF unit 171 such that the designated UHF channel is selected.

The retransmitted wave of the VHF band and the direct wave of the UHF band inputted in the TV receiver 106 are transmitted to the VHF/UHF duplexer 160. In the VHF/UHF duplexer 160, the retransmitted wave of the VHF band and the direct wave of the UHF band are frequency-separated so as not to interfere with each other. The retransmitted wave of the VHF band obtained by the VHF/UHF duplexer 160 is transmitted to the first RF/IF unit 161, and the direct wave of the UHF band obtained by the VHF/UHF duplexer 160 is transmitted to the second RF/IF unit 171.

The first RF/IF unit 161 down-converts TV broadcast signals (retransmitted wave signals) of the VHF channel corresponding to the designated UHF channel to baseband signals. The signals obtained by the first RF/IF unit 161 are digitally demodulated by the first OFDM demodulation unit 162, and then transmitted to a first input terminal of the selection switch 181 and to the VHF channel level detection unit 163. The VHF channel level detection unit 163 detects the level of received signals of the predetermined VHF channel obtained by the first OFDM demodulation unit 162, and gives it to the control unit 185.

The second RF/IF unit 171 down-converts TV broadcast signals (direct wave signals) of the designated UHF channel to baseband signals. The signals obtained by the second RF/IF unit 171 are digitally demodulated by the second OFDM demodulation unit 172, and then transmitted to a second input terminal of the selection switch 181 and to the UHF channel level detection unit 173. The UHF channel level detection unit 173 detects the level of received signals of the predetermined UHF channel obtained by the second OFDM demodulation unit 172, and gives it to the control unit 185.

The control unit 185 compares the received signal level of the VHF channel given by the VHF channel level detection unit 163 and the received signal level of the UHF channel given by the UHF channel level detection unit 173, and based on the comparison result, controls the selection switch 181. That is, when the received signal level of the VHF channel is larger than the received signal level of the UHF channel, the selection switch 181 is controlled such that the received signals of the VHF channel are selected. In contrast, when the received signal level of the UHF channel is larger than the received signal level of the VHF channel, the selection switch 181 is controlled such that the received signals of the UHF channel are selected.

The received signals selected by the selection switch 181 are transmitted to the AV decoding unit 182. In the AV decoding unit 182, the received signals are decoded, and video signals and audio signals are reproduced. The reproduced video signals are transmitted to the display unit (monitor) 183, and the reproduced audio signals are transmitted to the speaker 184.

If the RF/IF units 161 and 171 of the two systems is V support (with VHF filter) and U support (with UHF filter) respectively, TV broadcast signals (retransmitted wave of the VHF band and direct wave of the UHF band) inputted in the TV receiver 106 may be simply distributed to the RF/IF units 161 and 171 of the two systems.

2. Description of First Modification of TV Receiver

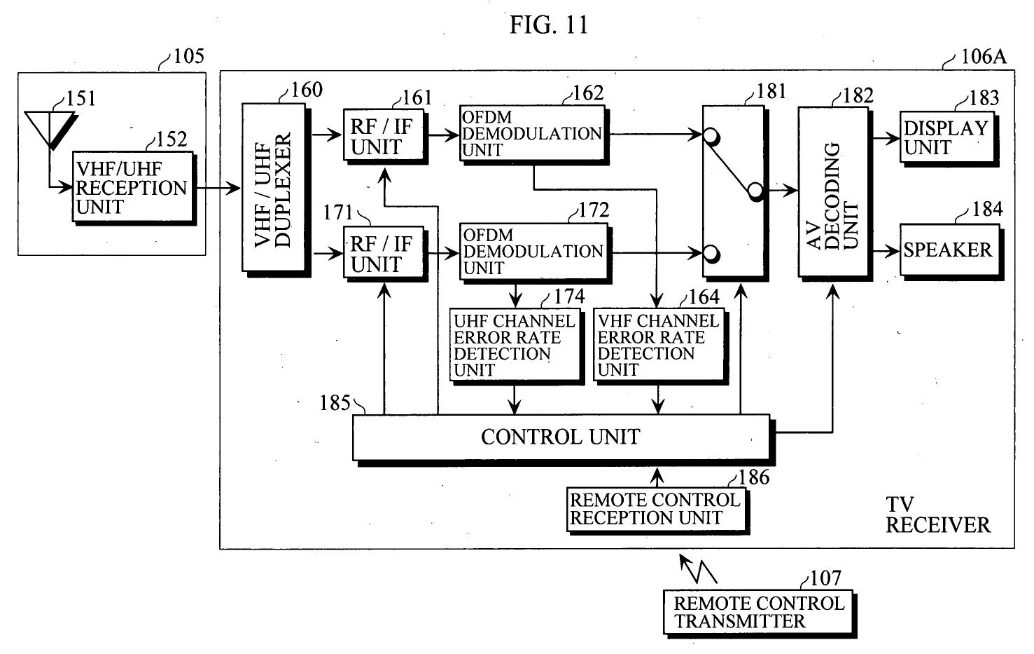

FIG. 11 shows a first modification of a TV receiver.

In FIG. 11, same components as those in FIG. 10 are denoted by the same reference numerals and their descriptions are omitted.

In the TV receiver 106 in FIG. 10, the received signal level of the VHF channel corresponding to the designated UHF channel and the received signal level of the designated UHF channel are compared, whereby the selection switch 181 is controlled.

On the other hand, in a TV receiver 106A in FIG. 11, the error rate of the VHF channel corresponding to the designated UHF channel and the error rate of the received signal level of the designated UHF channel are compared, whereby the selection switch 181 is controlled.

The error rate of the first OFDM demodulation unit 162 is detected by a VHF channel error rate detection unit 164. Further, the error rate of a second OFDM demodulation unit 172 is detected by a UHF channel error rate detection unit 174. The error rates detected by the both error rate detection units 164 and 174 are given to the control unit 185.

The control unit 185 compares the error rate of the received signals of the VHF channel given by the VHF channel error rate detection unit 164 with the error rate of the received signals of the UHF channel given by UHF channel error rate detection unit 174, and based on the comparison result, controls the selection switch 181. That is, when the error rate of the received signals of the VHF channel is lower than the error rate of the received signals of the UHF channel, the selection switch 281 is controlled such that the received signals of the VHF channel are selected. In contrast, when the error rate of the received signals of the UHF channel is lower than the error rate of the received signals of the. VHF channel, the selection switch 181 is controlled such that the received signals of the UHF channel are selected.

3. Description of Second Embodiment of TV Receiver

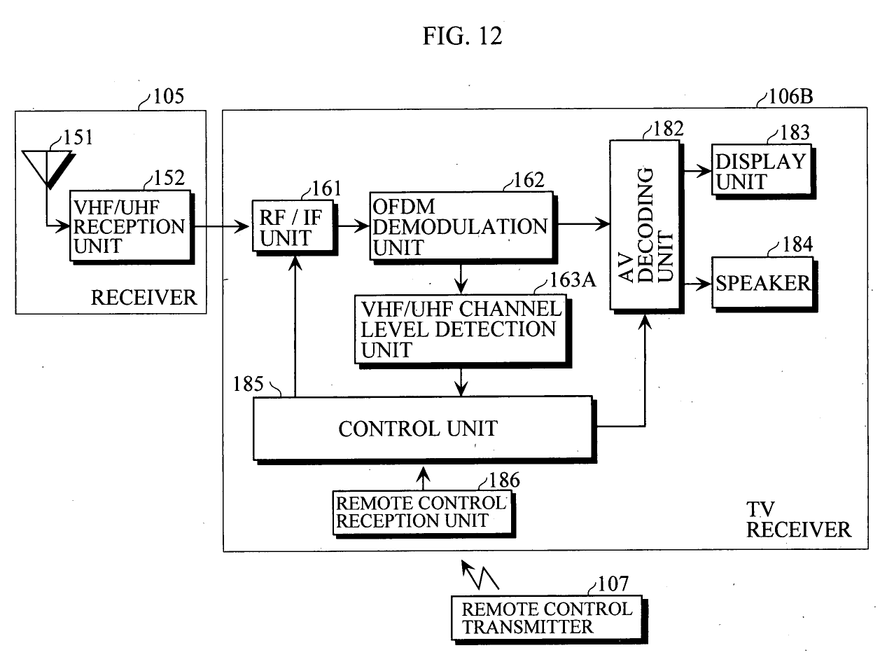

FIG. 12 shows a second modification of a TV receiver.

In FIG. 12, same components as those in FIG. 10 are denoted by the same reference numerals and their descriptions are omitted.

The TV receiver 106B has only one receiving system. The receiving system includes the RF/IF unit 161 and the OFDM demodulation unit 162. The retransmitted wave of the VHF band and the direct wave of the UHF band inputted in the TV receiver 106B are transmitted to the RF/IF unit 161.

On the TV receiver 106B side, a user designates a desired channel (UHF channel) of the terrestrial digital TV broadcasting by the remote control transmitter 107. The UHF channel designated by the remote control transmitter 107 is inputted into the control unit 185 via the remote control reception unit 186. The control unit 185 obtains a VHF channel corresponding to the inputted UHF channel, based on a table, as shown in Table 8 above, indicating the relationship between UHF channels and VHF channels (unused channels of VHF_SHB) corresponding thereto.

At the time of initial setting (for example, when the power is turned on), the control unit 185 first controls the RF/IF unit 161 such that a VHF channel corresponding to the designated UHF channel is selected. Therefore, the RF/IF unit 161 down-converts TV broadcast signals (retransmitted wave signals) of the VHF channel corresponding to the designated UHF channel to baseband signals. The signals obtained by the RF/IF unit 161 are digitally demodulated by the OFDM demodulation unit 162, and then transmitted to the AV decoding unit 182 and to the VHF/UHF channel level detection unit 163A. The VHF/UHF channel level detection unit 163A detects the level of received signals of the VHF channel obtained by the OFDM demodulation unit 162, and gives it to the control unit 185. The control unit 185 stores the level of the received signals of the VHF channel.

Then, the control unit 185 controls the RF/IF unit 161 such that the designated UHF channel is selected. Therefore, the RF/IF unit 161 down-converts TV broadcast signals (direct wave signals) of the designated UHF channel to baseband signals. The signals obtained by the RF/IF unit 161 are digitally demodulated by the OFDM demodulation unit 162, and then transmitted to the AV decoding unit 182 and to the VHF/UHF channel level detection unit 163A. The VHF/UHF channel level detection unit 163A detects the level of received signals of the UHF channel obtained by the OFDM demodulation unit 162, and gives it to the control unit 185. The control unit 185 compares the level of the received signals of the UHF channel and the level of the received signals of the VHF channels previously stored. Then, the control unit 185 controls the RF/IF unit 161 so as to select a channel (VHF channel or UHF channel) in which the signal level is higher.

In this way, received wave to be reproduced is selected and set, out of the retransmitted wave of the VHF band and direct wave of the UHF band inputted in the TV receiver 106B at the time of initial setting. After the received wave is selected and set, the setting is maintained until the receiving becomes impossible or the power turned off.

4. Description of Third Modification of TV Receiver

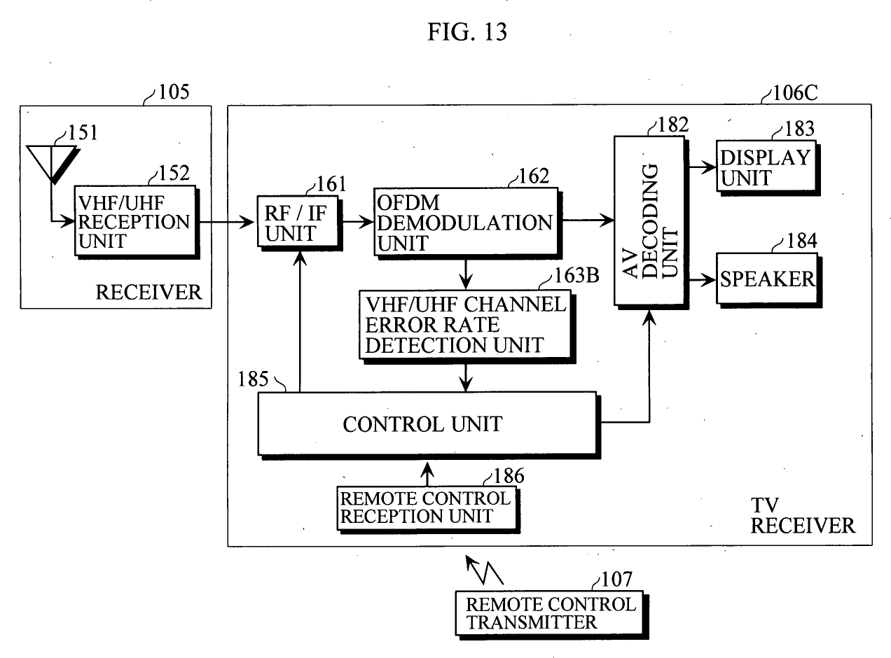

FIG. 13 shows a third modification of a TV receiver.

In FIG. 13, same components as those in FIG. 12 are denoted by the same reference numerals and their descriptions are omitted.

The TV receiver 106C of FIG. 13 is only different in that a VHF/UHF channel error rate detection unit 163B is used instead of the VHF/UHF channel level detection unit 163A of the TV receiver shown in FIG. 12.

At the time of initial setting (for example, when the power is turned on), the control unit 185 first controls the RF/IF unit 161 such that a VHF channel corresponding to the designated UHF channel is selected. Therefore, the RF/IF unit 161 down-converts TV broadcast signals (retransmitted wave signals) of the VHF channel corresponding to the designated UHF channel to baseband signals. The signals obtained by the RF/IF unit 161 are digitally demodulated by the OFDM demodulation unit 162, and then transmitted to the AV decoding unit 182 and to the VHF/UHF channel error rate detection unit 163B. The VHF/UHF channel error rate detection unit 163B detects the error rate of received signals of the VHF channel obtained by the OFDM demodulation unit 162, and gives it to the control unit 185. The control unit 185 stores the error rate of the received signals of the VHF channel.

Then, the control unit 185 controls the RF/IF unit 161 such that the designated UHF channel is selected. Therefore, the RF/IF unit 161 down-converts TV broadcast signals (direct wave signals) of the designated UHF channel to baseband signals. The signals obtained by the RF/IF unit 161 are digitally demodulated by the OFDM demodulation unit 162, and then transmitted to the AV decoding unit 182 and to the VHF/UHF channel error rate detection unit 163B. The VHF/UHF channel error rate detection unit 163B detects the error rate of received signals of the UHF channel obtained by the OFDM demodulation unit 162, and gives it to the control unit 185. The control unit 185 compares the error rate of the received signals of the UHF channel with the error rate of the received signals of the VHF channels previously stored. Then, the control unit 185 controls the RF/IF unit 161 so as to select a channel (VHF channel or UHF channel) in which the error rate is lower.

In this way, received wave to be reproduced is selected and set, out of the retransmitted wave of the VHF band and direct wave of the UHF band inputted in the TV receiver 106C at the time of initial setting. After the received wave is selected and set, the setting is maintained until the receiving becomes impossible or the power turned off.

C. Description of Application of This Invention in the United States

In Japan, a frequency band where restriction relating to the electric field intensity is lenient with respect to the frequency band is less than 322 MHz, as described above. Therefore, in the first and second embodiments described above, the frequency conversion unit 42 in the transmitters 4 and 4A converts the frequency of terrestrial digital TV signals (TV signals of UHF band) to a frequency of an unused channel of the VHF band less than 322 MHz where restriction in weak radio wave standard is lenient.

In the United States, on the other hand, a UHF band is a frequency band between 470 MHz and 890 MHz, and a VHF band is a frequency band between 54 MHz and 470 MHz. According to the Radio Law of the United States, a frequency band where restriction relating to the electric field intensity is lenient with respect to the frequency band is between 260 MHz and 470 MHz.

Therefore, when the present invention is applied in the United States, a frequency conversion unit in a transmitter may convert the frequency of terrestrial digital TV signals (TV signals of the UHF band) of a desired channel to a frequency of an unused channel of the VHF band within a range between 260 MHz and 470 MHz where restriction relating to the electric field intensity with respect to the frequency band is lenient.

What is claimed is:

1. A wireless redistribution system for terrestrial digital TV broadcasting, applied to a TV receiver capable of receiving signals of a VHF band in addition to signals of a UHF band as a frequency band of terrestrial digital TV broadcast signals, the system comprising:
a transmitter, into which terrestrial digital TV broadcast signals received by an outdoor antenna are inputted, for converting a frequency of the inputted terrestrial digital TV broadcast signals to a frequency of an unused channel of the VHF band collectively, and then amplifying and transmitting them wirelessly; and
a receiver for receiving and amplifying signals transmitted from the transmitter, and then supplying them to the TV receiver.

2. The wireless redistribution system for terrestrial digital TV broadcasting according to claim 1, wherein
the transmitter converts the frequency of the inputted terrestrial digital TV broadcast signals to a frequency of an unused channel of the VHF band within a range between 260 MHz and 470 MHz collectively, and then amplifies and transmits them wirelessly.

3. A wireless redistribution system for terrestrial digital TV broadcasting, applied to a TV receiver capable of receiving TV broadcast signals of a VHF band in addition to TV broadcast signals of a UHF band as a frequency band of terrestrial digital TV broadcast signals, the system comprising:
a transmitter into which terrestrial digital TV broadcast signals or terrestrial digital TV broadcast signals having been frequency-converted to the VHF band are inputted, in which when inputted TV broadcast signals are terrestrial digital TV broadcast signals of the UHF band, the transmitter converts the frequency of the inputted TV broadcast signals to a frequency of an unused channel of the VHF band collectively and then amplifies and transmits them wirelessly, and when the inputted TV broadcast signals are terrestrial digital TV broadcast signals having been frequency-converted to the VHF band, the transmitter amplifies the inputted TV broadcast signals straightly and transmits them wirelessly; and
a receiver for receiving and amplifying signals transmitted from the transmitter, and then supplying them to the TV receiver.

4. The wireless redistribution system for terrestrial digital TV broadcasting according to claim 3, wherein
the transmitter includes:
first means for extracting TV broadcast signals of the VHF band from the inputted TV broadcast signals, and based on a signal level of the TV broadcast signals of the VHF band extracted, determining whether the inputted TV broadcast signals are the terrestrial digital TV broadcast signals of the UHF band or the terrestrial digital TV broadcast signals having been frequency-converted to the VHF band;
second means for converting the frequency of the inputted TV broadcast signals to a frequency of an unused channel of the VHF band collectively and then amplifying and transmitting them wirelessly, when the inputted TV broadcast signals are determined as the terrestrial digital TV broadcast signals of the UHF band; and
third means for amplifying and wirelessly transmitting the inputted TV broadcast signals straightly, when the inputted TV broadcast signals are determined as the terrestrial digital TV broadcast signals having been frequency-converted to the VHF band.

5. The wireless redistribution system for terrestrial digital TV broadcasting according to claim 4, wherein
the second means converts the frequency of the inputted TV broadcast signals to a frequency of an unused channel of the VHF band within a range between 260 MHz and 470 MHz collectively, and then amplifies and transmits them wirelessly.

6. A receiving system for terrestrial digital TV broadcasting comprising:
a wireless redistribution system for wirelessly retransmitting terrestrial digital TV broadcast signals received by an outdoor antenna to a TV receiver; and
a direct receiving system for inputting terrestrial digital TV broadcast signals to the TV receiver directly via an indoor antenna, wherein
the TV receiver includes:
selection means for selecting TV broadcast signals of higher receiving quality out of the TV broadcast signals supplied by the wireless redistribution system and the TV broadcast signals supplied by the direct receiving system; and
reproduction means for reproducing the TV broadcast signals selected by the selection means.

7. The receiving system for terrestrial digital TV broadcasting according to claim 6, wherein
the selection means compares a received signal level of the TV broadcast signals supplied by the wireless redistribution system with a received signal level of the TV broadcast signals supplied by the direct receiving system to thereby select TV broadcast signals of higher receiving quality.

8. The receiving system for terrestrial digital TV broadcasting according to claim 6, wherein
the selection means compares a received signal error rate of the TV broadcast signals supplied by the wireless redistribution system with a received signal error rate of the TV broadcast signals supplied by the direct receiving system to thereby select TV broadcast signals of higher receiving quality.

9. The receiving system for terrestrial digital TV broadcasting according to claim 6, wherein
the wireless redistribution system comprises:
a transmitter for converting a frequency of the terrestrial digital TV broadcast signals received by the outdoor antenna to a frequency of an unused channel of the VHF band, and then amplifying and transmitting them wirelessly; and
a receiver for receiving and amplifying signals transmitted from the transmitter and then supplying them to the TV receiver.

10. The receiving system for terrestrial digital TV broadcasting according to claim 9, wherein
the transmitter converts a frequency of the terrestrial digital TV broadcast signals received by the outdoor antenna to a frequency of an unused channel of the VHF band within a range between 260 MHz and 470 MHz collectively, and then amplifies and transmits them wirelessly.
